(19) United States
(12) Patent Application Publication
(10) Pub. No.: US 2005/0287981 A1
(43) Pub. Date: Dec. 29, 2005

(54) Mobile phone personal alert device (PAD)

(76) Inventor: Gregory Roy Hill, Ipswich (AU)

Correspondence Address: GREGORY ROY HILL, P.O. Box 313, BOOVAL, 4304, AU

(21) Appl. No.: 11/110,963

(22) Filed: Apr. 21, 2005

(30) Foreign Application Priority Data
May 14, 2004 (AU) 2004902547

(51) Int. Cl. H04M 11/04

(52) U.S. Cl. 455/404.1; 455/550.1

(57) ABSTRACT

The mobile phone personal alert device, (PAD) is a self powered detachable component of a mobile phone. The PAD can be carried separately by the owner. Electronic circuitry including a low power matched transmitter/receiver is fitted within both the mobile phone and the PAD. If the two units become separated by a certain distance, an audible alert is triggered in both units. If the units are not reunited within a preset time, the mobile phone will advance to an alarm sound, and all services normally available to that mobile phone will be deactivated. The alert sound emitted from the PAD can be cancelled by way of a push button on the base of the PAD. Various alert/alarm signals and on/off functions within the mobile phone can be accessed by way of a predetermined Pin on the phone keypad. When not in use, the PAD is inserted back into the purpose built socket in the mobile phone shell body, enabling the PAD batteries to be recharged from the mobile phone battery.

### BACKGROUND OF THE INVENTION

Since the introduction of the mobile phone, many people have experienced the inconvenient problem of misplacing or losing their mobile phone, or having their mobile phone stolen. As well as the cost of replacing the lost or stolen mobile phone, the opportunity exists for others to make unauthorised calls at the expense of the owner. The mobile phone Personal Alert Device (PAD) is a small self powered electronic device that is supplied as part of the manufacturing process of the mobile phone. The PAD has been specially devised to provide maximum security against loss or theft of a mobile phone.

### BRIEF SUMMARY OF THE INVENTION

The object of the disclosed invention is to provide the owner of a mobile phone the opportunity to guard against the loss, theft or unauthorised use of their mobile phone. The mobile phone Personal Alert Device (PAD) is a small self powered detachable electronic device that is supplied as part of the manufacturing process of the mobile phone.

The PAD is a robust tubular housing which contains miniature electronic circuitry and is normally fitted in a purpose built socket in the shell body of the mobile phone. The PAD can be withdrawn from the socket in the mobile phone, and attached to a key ring or handbag or any item normally kept with the owner. Both the mobile phone and the PAD contain a transmitter/receiver, and both units transmit and receive signals to and from each other over a short distance at regular intervals.

If the units are separated by more than the predetermined distance, an audible alert is triggered in both units. The alert sound emitted from the PAD can be cancelled by way of a push button on the base of the PAD. If the units are not reunited within a preset time, the mobile phone will advance to an alarm sound, and all services normally available to that mobile phone will be deactivated. Various alert/alarm signals and on/off functions within the mobile phone can be accessed by way of a predetermined Pin on the phone keypad. When not in use, the PAD is inserted back into the purpose built socket in the mobile phone shell body, enabling the PAD batteries to be recharged from the mobile phone battery.

The PAD may be better understood from the following detailed description when read in conjunction with the appended drawings, in which:

### BRIEF DESCRIPTION OF THE DRAWINGS

FIG. 1 is a perspective view of the PAD unit removed from it's housing in the mobile phone.

FIG. 2 is a perspective view of the mobile phone showing the PAD unit installed in it's housing.

FIG. 3 is a perspective view of the mobile phone showing the PAD unit removed from it's housing.

### DETAILED DESCRIPTION OF THE INVENTION

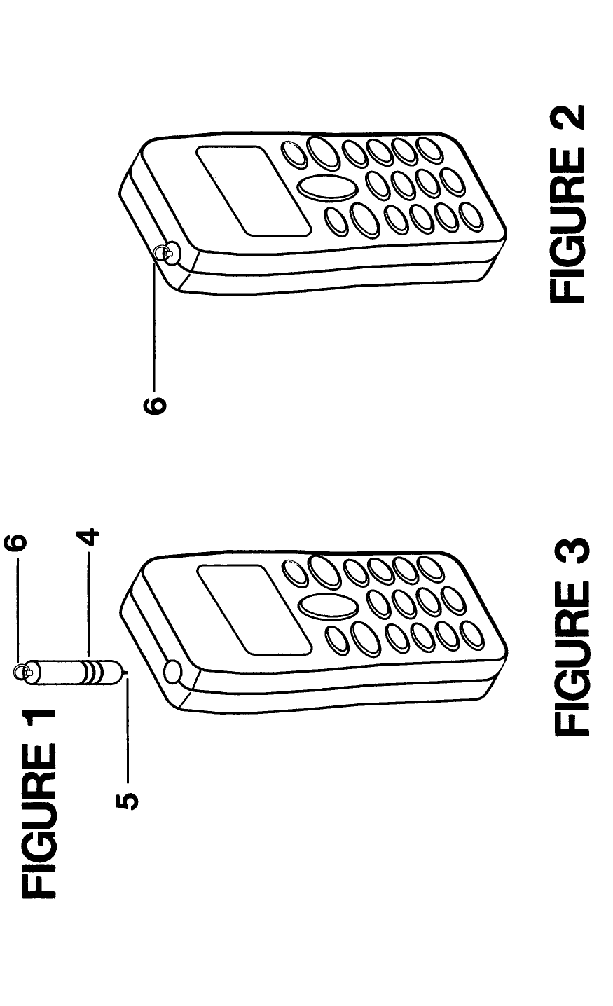

As shown in FIG. 1 the mobile phone “Personal Alert Device”, hereafter referred to as PAD, is a robust tubular housing with a key ring attachment 6 at the top and a reset push button switch 5 at the bottom and a number of circular contact rings 4 around it's circumference . These contact rings make contact with internal contacts in the mobile phone when the PAD is fully inserted in the mobile phone housing. These contact rings cannot be shorted out by metallic car keys etc. as they only come into operation when the PAD is inserted in the mobile phone housing and the switch 5 is fully depressed.

The electronic circuitry contained in the robust tubular housing consists of a low power transmitter/receiver, a timer and counter and an audible device. It is powered by self contained rechargeable batteries. The batteries in the PAD are recharged from the mobile phone battery by way of the contact rings 4. When the PAD is removed from the mobile phone, a spring loaded flap seals the entrance to the PAD receptacle in the mobile phone to prevent entry of any foreign material.

An on/off function for the operation of the mobile phone alert and PAD can be accessed by a predetermined Pin number on the mobile phone key pad. When the PAD is unplugged from the mobile phone, both the mobile phone and the PAD are activated and enter the mode hereafter referred to as the “Normal Mode” whereby the PAD and the mobile phone talk to each other by way of a low power transmitter/receiver fitted within both the mobile phone and the PAD. Each matched mobile phone and PAD would operate on it's own individual frequency.

The strength of the signal need not reach a distance of more than 5 metres. Every 2 seconds, a brief pulse signal would be transmitted from both the mobile phone and the PAD, and if both the mobile phone and the PAD receive their matched incoming signal, this normal mode continues indefinitely.

A counter is also incorporated in the circuitry of both the mobile phone and PAD. If the mobile phone becomes separated from the PAD by a distance of more than 5 metres, both the mobile phone and the PAD continue transmitting a signal every 2 seconds. After each counter has recorded 3 consecutive periods of 2 seconds without receiving an incoming signal, the circuitry progresses to the “Alert Mode” whereby a low decibel alert signal is emitted from both the mobile phone and the PAD to alert the owner that they have become separated from their mobile phone.

The audible alert in the PAD can be quickly cancelled at this point by simply pressing the push button 5 located on the bottom of the housing. This then gives the owner the opportunity to locate the mobile phone by following the low decibel alert signal being emitted from the lost mobile phone. If the mobile phone and the PAD are reunited within a period of time of less than 1 minute, both the mobile phone alert and the PAD are reset by their own circuitry and return to their normal mode. This would be the usual case if the mobile phone was left at a restaurant table or left behind after a meeting, and the low decibel alert would not be of major concern to the public. If the period of separation of the mobile phone and the PAD exceeds 1 minute, the mobile phone then enters the next mode, herein after called the “Alarm Mode”.

In the alarm mode the alert signal in the mobile phone changes to a high decibel alarm pitch and all services normally available to that mobile phone are deactivated. A locking device to prevent the battery from being removed from the mobile phone at this point may also be incorporated. Any unauthorised person being in possession of the mobile phone at this time would draw unwanted attention to themselves, and would quickly discard the mobile phone thereby giving the owner a reasonable chance to hear the alarm signal and retrieve the lost mobile phone.

The mobile phone would continue in the alarm mode until either:

1. The owner inserts the PAD into the receptacle in the mobile phone.

2. A predetermined Pin number is entered into the mobile phone.

3. The battery of the mobile phone becomes exhausted.

The batteries contained in the PAD would normally be recharged from the main mobile phone battery at any time when the PAD is inserted in the socket in the mobile phone. If the batteries in the PAD become low during normal use a low battery audible signal would alert the owner. A variety of alert tones and alarm tones for the mobile phone can be selected by the owner from a menu in the mobile phone. A facility to record a personal voice message for both the alert and alarm modes is also available. An added advantage of this system is that if the PAD is attached to car keys or a handbag, the audible alert of the mobile phone would indicate to the owner that the car keys or handbag have been misplaced or stolen. In this case, if the PAD is not quickly found, the mobile phone alert alarm can be silenced by entering the predetermined pin into the mobile phone.

Although the present invention has been described with reference to the preferred embodiment thereof, it will be understood that the invention is not limited to the details thereof Numerous variations, substitutions, timer changes and other modifications will occur; therefore, all such changes and modifications are intended to be embraced within the scope of the invention as defined in the appended claims.

1. A Personal Alert Device (PAD) comprising a small self powered electronic device which is removeable from a purpose built socket incorporated in it's matched mobile phone.

2. A Personal Alert Device (PAD) as claimed in claim 1, wherein a transmitter/receiver fitted within both the mobile phone and the PAD allows both units to “talk” to each other over a short distance.

3. A Personal Alert Device (PAD) as claimed in 1 and 2, wherein an “alert” signal is triggered in both the PAD and the mobile phone if both units become separated by more than a pre-determined distance.

4. A Personal Alert Device (PAD) as claimed in 1-3, wherein the “alert” signal in the mobile phone changes to an “alarm” signal after a pre-determined time.

5. A Personal Alert Device (PAD) substantially as herein before described with reference to FIGS. 1-3 of the accompanying drawings.
